(19) United States
(12) Patent Application Publication
(10) Pub. No.: US 2007/0236347 A1
(43) Pub. Date: Oct. 11, 2007

(54) Locating apparatus for battery operated electronic devices

(75) Inventors: Michael Francois, Coral Springs, FL (US); Michael Anthony, Coral Springs, FL (US)

Correspondence Address: MARK D. BOWEN, ESQ.;Sterns, Weaver, Miller, Weissler, Alhadeff & Sitte, NEW RIVER CENTER, 200 EAST LAS OLAS BLVD, SUITE 2100, FT. LAUDERDALE, FL, 33301, US

(73) Assignee: MICHAEL FRANCOIS

(21) Appl. No.: 11/391,621

(22) Filed: Mar. 28, 2006

(51) Int. Cl. G08B 1/08

(52) U.S. Cl. 340/539.32; 340/539.13

(57) ABSTRACT

An electronic locator apparatus that is attachable to a personal electronic device, such as a cellular telephone, and adapted for detecting the presence of an electromagnetic field generated by battery powered electronics within the telephone so as to automatically generate an audible signal when the telephone is lost and the battery dies.

### CROSS REFERENCE TO RELATED APPLICATIONS

N/A

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

The present invention relates to battery operated electronic devices, such as cellular telephones. More particularly, the present invention relates to a locator device for use in locating a cellular telephone that has lost its battery charge.

2. Description of Related Art

The number of cellular telephones in use has increased significantly over the last decade. One problem often encountered by cellular phone owners involves locating a lost or misplaced telephone. In such situations, the phone owner typically calls his or her phone from another phone in the hope of locating the misplaced phone by hearing the corresponding ring tone. While this method is generally useful allowing the user to locate a phone that has been recently misplaced, such as at home, the method involves certain limitations. Chief among those limitations is the requirement that the telephone have a charged battery in order to generate a ring tone.

In addition, the prior art includes U.S. Pat. No. 4,507,653, issued on Mar. 26, 1985, to Bayer, which describes an object finder device which can be mounted on a personal item and responds by an audible signal to a predetermined sound such as hand clapping, whistling, and the like. The effectiveness of this device would necessarily be limited to the range where the designated sound reaches a threshold level.

As a result there exists a need for an improved locator apparatus and method to assist user's in locating misplaced cellular telephones.

### BRIEF SUMMARY OF THE INVENTION

The present invention overcomes the disadvantages in the art by providing an electronic locator apparatus that is attachable to a personal electronic device, such as a cellular telephone, and adapted for detecting the presence of an electromagnetic field generated by battery powered electronics within the telephone so as to automatically generate an audible signal when the telephone is lost and the battery dies.

Accordingly, it is an object of the present invention to provide a locator apparatus that is attachable to a personal electronic device and adapted to generate an audible tone when the battery dies.

Another object of the present invention is to provide a sensitive electromagnetic field sensor for use with personal electronic devices.

Yet another object of the present invention is to provide a method for locating lost electronic devices that have no battery power.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 is a rear perspective view of a locating device illustrating an adhesive attachment system in accordance with the present invention;

FIG. 2 is front perspective view thereof;

FIG. 3 is a perspective view of a circuit board for an electromagnetic field sensor in accordance with the present invention;

FIG. 4 is a rear perspective view illustrating a locating device in accordance with the present invention attached to a cellular telephone;

FIG. 5 is a front perspective view thereof;

FIG. 6 depicts a cellular telephone emitting an electromagnetic field adjacent to a circuit board for an electromagnetic field sensor in accordance with the present invention;

FIG. 7 is a flowchart illustrating the functionality of locating device in accordance with the present invention; and

FIG. 8 is an electrical circuit diagram for an electromagnetic field sensor in accordance with the present invention.

### DETAILED DESCRIPTION OF THE INVENTION

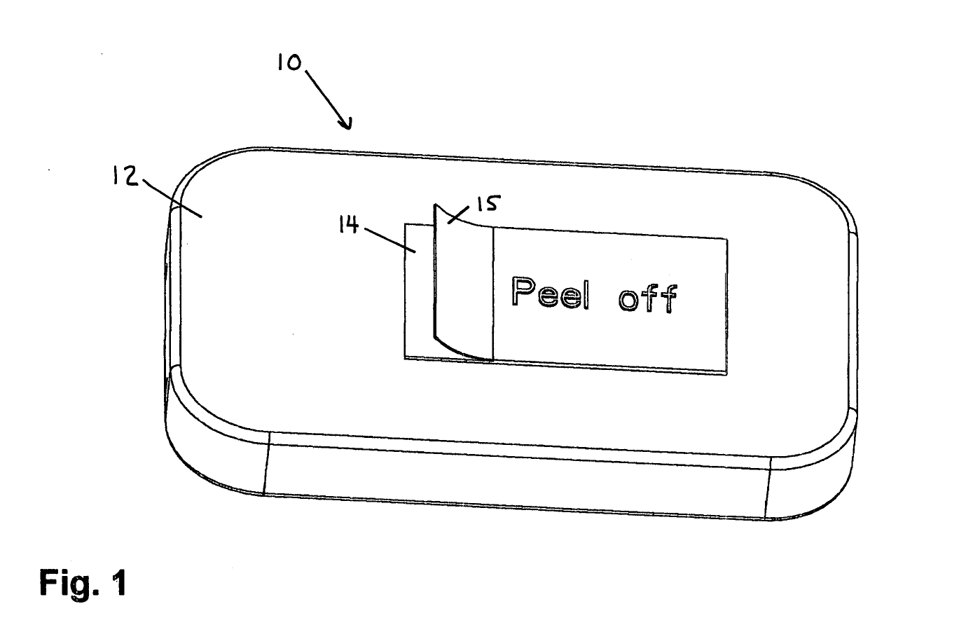

With reference to the drawings, FIGS. 1-8 depict a preferred embodiment of a locating apparatus for personal electronic devices, generally referenced as 10. Locating apparatus 10 is preferably adapted for attachment to a personal electronic device, such as a cellular telephone, and adapted for detecting an electromagnetic field generated by battery powered electronics within the telephone and is triggered by the absence of the electromagnetic field so as to automatically generate an audible signal when the telephone is lost and the battery dies.

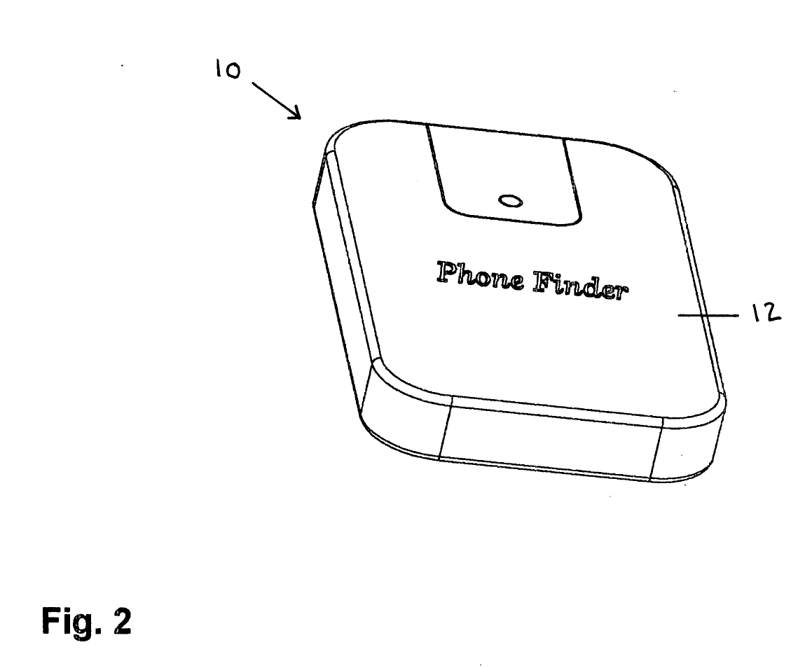

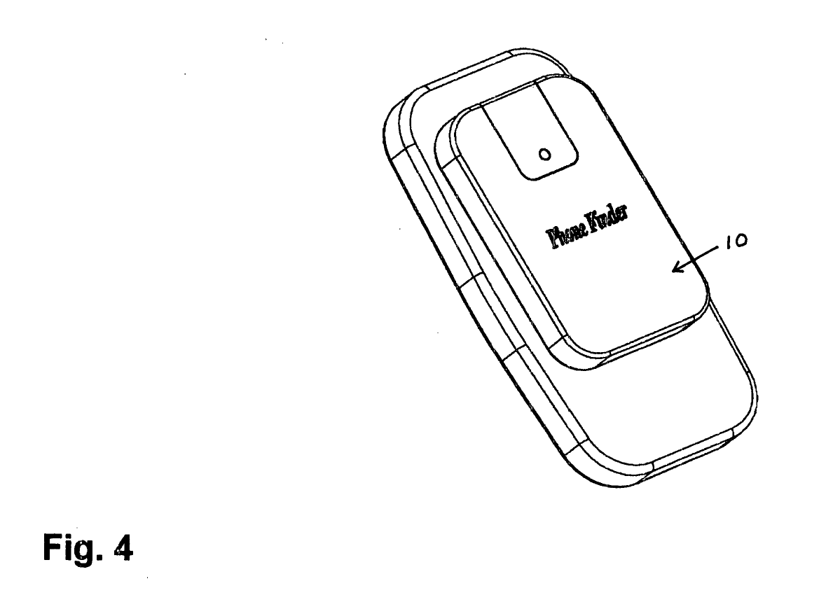

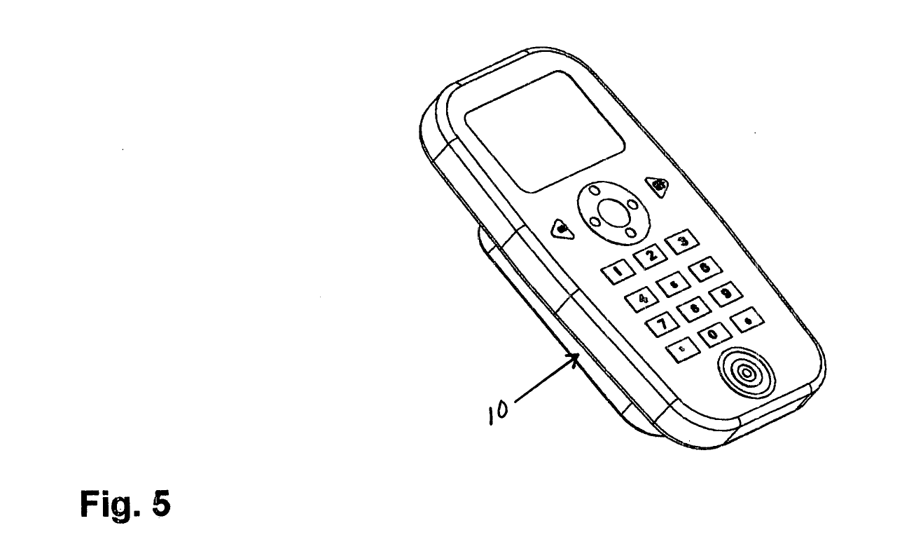

FIGS. 1 and 2 generally depict rear and front perspective views of a housing 12 for locating device 10. Housing 12 is preferably fabricated from a lightweight plastic. As best seen in FIG. 1, housing 12 preferably includes an adhesive strip 14 that functions to adhesively secure device 10 to a personal electronic devices, such as a cellular telephone. Adhesive strip 14 preferably includes a peel off protective layer 15 that must be removed to expose strip 14. FIGS. 4 and 5 depict locating device 10 adhesively attached to a cellular telephone. As should be apparent, housing 12 is preferably compact so a not to materially increase the overall dimensions of the electronic device.

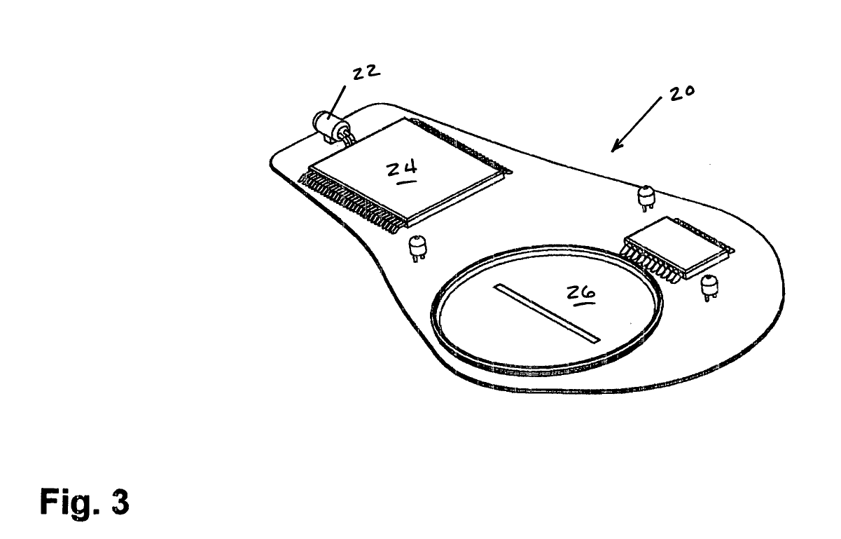

FIG. 3 depicts a circuit board, generally referenced as 20, containing the electronics required for detecting an electromagnetic field and generating an audible tone in response to the absence of the field. Circuit board 20 preferably includes a battery power source 22, an electromagnetic field sensor 24, and a piezoelectric buzzer 26. Battery power source 22 is preferably a small battery capable of powering buzzer 26. Electric magnetic field sensor 24 is preferably adapted to detect the presence of a low level electromagnetic field, of the type generated by a personal electronic device, such as a cellular telephone when the battery is charged and powering various phone features, such as the phone display, clock, etc. Piezoelectric buzzer 26 is preferably capable of generating a loud tone.

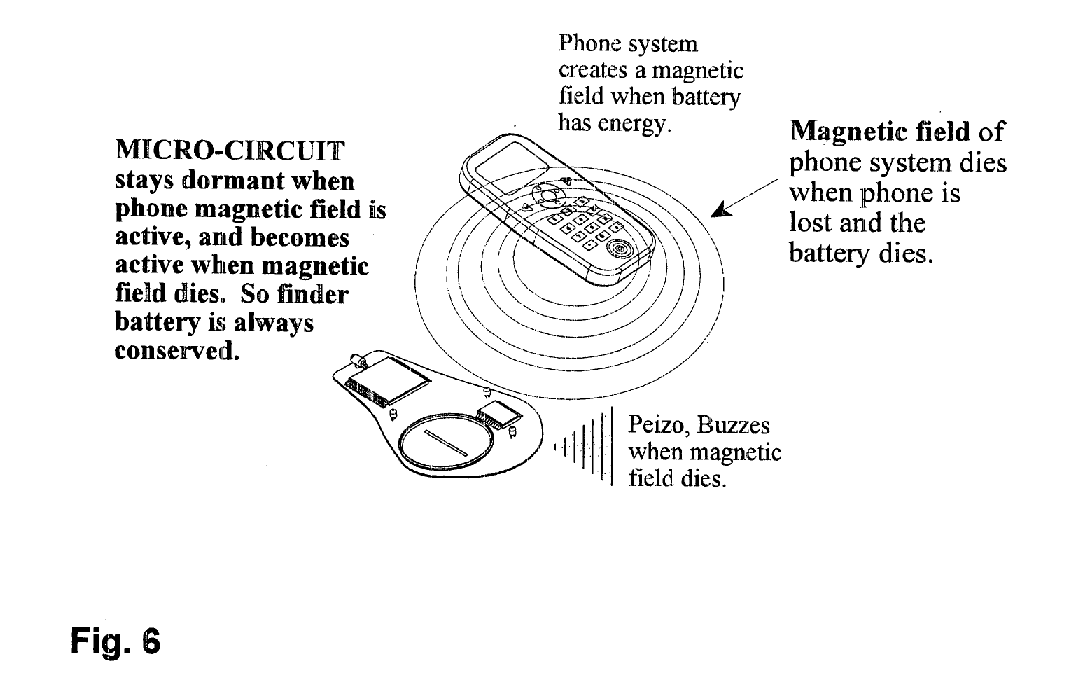

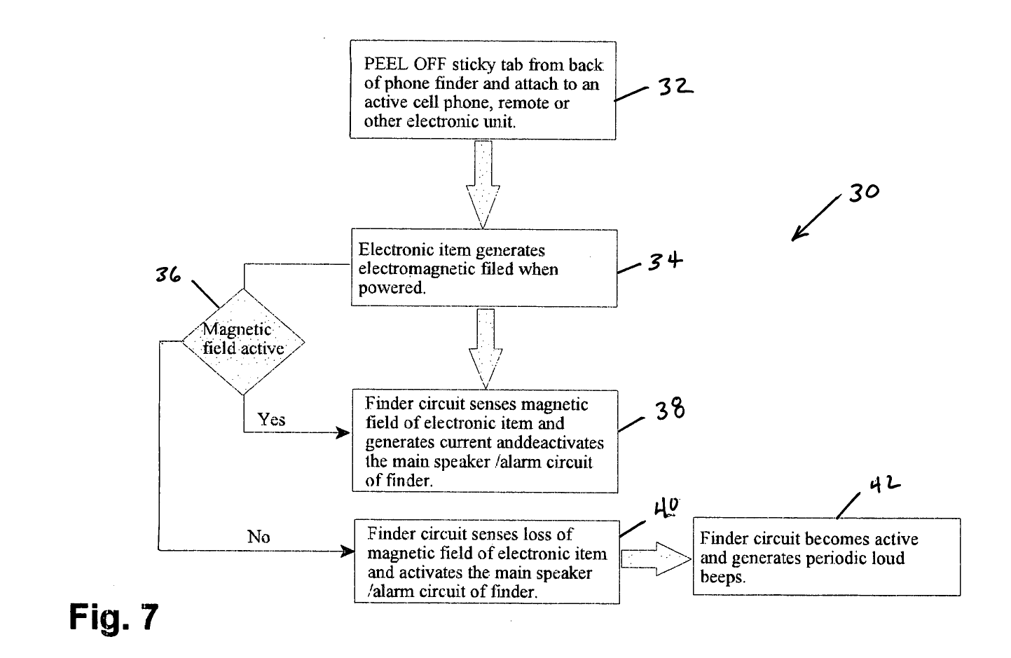

FIGS. 6 and 7 illustrate operational aspects of a locating device in accordance with the present invention. As best depicted in FIG. 6, locating device is placed in close proximity to a personal electronic device, such as a cellular telephone, such as by adhesive attachment as discussed above. As is known in the art electronics within a cellular telephone generate an electromagnetic filed that results from the electrical current and other electronic activity. This field is detectable, and indicates that the electronic device has battery power. As should be apparent, the magnetic filed generated by the device dies when the battery providing power to the device becomes uncharged, e.g. battery dies. This often occurs when the user misplaces the phone and is unable to locate same for a period of time sufficient to drain the battery. Accordingly, locator device 10 includes a circuit board 20 that senses the presence of the electromagnetic filed and remains dormant in the presence of the field thereby conserving battery 22. If the phone battery dies, however, the absence of the electromagnetic field is detected by sensor 24 and piezoelectric buzzer 26 is triggered thereby generating an audible tone to assist the phone owner, or other persons in proximity, in locating the phone.

FIG. 7 depicts a flowchart 30 illustrating use of a locating device in accordance with the present invention. First, as illustrated in block 32 the user peels off the protective layer 15 thereby exposing the adhesive strip and attaches locator device 10 to a cellular telephone or other personal electronic device. As illustrated by block 34 the cellular telephone generates an electromagnetic field when powered. As illustrated by block 36, locator device senses the presence of an active electromagnetic field. As illustrated by block 38, when the locator device senses the electromagnetic field the audible alarm circuit is deactivated. If however, as illustrated by block 40, the locator device does not detect the electromagnetic field then the audible alarm circuit is energies and a loud periodic tone is generated, block 42.

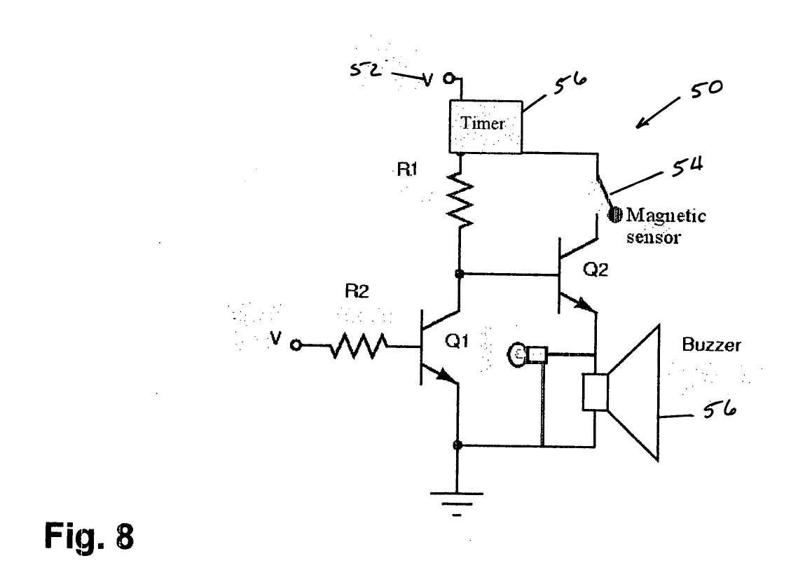

FIG. 8 depicts an electrical schematic, generally referenced as 50, for a locator device in accordance with the present invention. The components include a battery power source 52, an electromagnetic field sensor 54, and a piezoelectric buzzer 56. In addition, a timer circuit 58 is further provided to control periodic tone generation.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A locator apparatus for use with a personal electronic device, said locator apparatus comprising:
a housing adapted for attachment to the personal electronic device;
said housing containing an electrical power source, means for sensing electromagnetic energy, and means for generating an audible tone when no electromagnetic energy is sensed.

2. A locator apparatus according to claim L, wherein said electrical power source is a battery.

3. A locator apparatus according to claim 1, wherein said means for generating an audible tone includes a piezoelectric buzzer.

4. A locator apparatus for use with a personal electronic device, said locator apparatus comprising:
a housing adapted for attachment to the personal electronic device;
an electrical power source contained within said housing;
an electromagnetic sensor in electrical communication with said electrical power source;
a piezoelectric buzzer in electrical communication with said power source and said sensor;
said piezoelectric buzzer configured to periodically generate an audible tone when said electromagnetic sensor fails to detect an electromagnetic field.
